(19) United States
(12) Patent Application Publication
(10) Pub. No.: US 2007/0150362 A1
(43) Pub. Date: Jun. 28, 2007

(54) Location-based comparative shopping service for wireless telecommunications network

(76) Inventors: Ranjan Sharma, New Albany, OH (US); Shengqiang Wang, Raleigh, NC (US)

Correspondence Address: FAY SHARPE/LUCENT, 1100 SUPERIOR AVE, SEVENTH FLOOR, CLEVELAND, OH, 44114, US

(21) Appl. No.: 11/311,784

(22) Filed: Dec. 19, 2005

(51) Int. Cl. G06Q 30/00

(52) U.S. Cl. 705/26

(57) ABSTRACT

A method of providing a location-based comparative shopping service (30) to a subscriber includes: receiving a request to conduct a search for a product from the subscriber via a mobile station (20) being served by a wireless telecommunications network (10); determining a location of the mobile station (20); generating a query from at least one of the received request and the determined location; submitting the query to a shopping engine (42), the shopping engine (42) generating results in response thereto, the results including a number of entries satisfying the query; receiving the result entries generated by the shopping engine (42); and, forwarding selected result entries to the mobile station (20) via the wireless telecommunications network (10).

### FIELD

The present inventive subject matter relates to the telecommunication arts. One particular application is found in conjunction with comparative shopping via a wireless telecommunications network, and the specification makes particular reference thereto. However, it is to be appreciated that aspects of the present inventive subject matter are also amenable to other like applications.

### BACKGROUND

Generally, when shopping for products and/or services, a consumer often desires to compare and/or consider various factors before determining if they are actually going to make a purchase, what brand and/or model they are going to purchase, where they are going to make the purchase and/or from whom they are going to purchase the products and/or services. For example, such factors may typically include any one or more of the following: the price of the product, the identity of the merchant selling the goods and/or services, the location of the merchant, the quality of the product, warranties on the product, financing options, related sales incentives (i.e., free bonuses or gifts, cash back, frequent shopper points, etc.), and other like factors. However, traveling from merchant to merchant to collect the relevant information so as to be able to make an informed decision and/or comparison regarding a contemplated purchase can be burdensome and/or impractical.

To facilitate comparison shopping for consumers, there has been developed a number of Internet shopping engines and/or websites. Such Internet shopping engines and/or websites include, e.g., Froogle, Yahoo!® Shopping, PriceGrabber.com, BizRate, GasBuddy.com, GasPriceWatch.com, as well as many others. The typical shopping engine is traditionally accessed over the Internet from a consumer's desktop computer using an appropriate web-browser or other like application. In the usual manner, the consumer enters and/or otherwise submits the name, description and/or other identifying characteristic of the product they are searching for, and in response, the shopping engine returns a list of results that satisfy the criteria. Depending on the particular shopping engine, the results often include a list of various merchants where the product or products matching the criteria are available for purchase along with the purchase price at each of the various merchants. In his manner, the consumer's comparison shopping experience is facilitated. However, the conventional Internet shopping engines have some limitations that in certain circumstances may be disadvantageous.

While generally acceptable for preplanned shopping experiences, conventional Internet shopping engines alone are often less helpful for impromptu shopping experiences. For example, in a typical preplanned shopping experience, the consumer can use the shopping engine of their choice to shop from their home or office over the Internet (i.e., to compare product offerings from different merchants) and then travel directly to a selected merchant to complete their purchase after they have decide where and/or from whom they are making the purchase. On the contrary, impromptu shoppers are typically already away from their homes and/or offices when they decide to do their shopping. Accordingly, they may not have convenient access to the conventional Internet shopping engines. Additionally, impromptu shoppers may only want to shop in and/or around their current vicinity and the conventional Internet shopping engines typically have no way of determining the shoppers current location. Moreover, if the impromptu shopper is in an unfamiliar location or area (e.g., while traveling on an Interstate), they may not be able to readily provide the shopping engine with a suitable identification of their current location, i.e., one that would be recognized by the shopping engine. For example, Internet shopping engines commonly call for the user to manually enter and/or submit a zip code in order for a search to be narrowed to that particular geographic location. However, shoppers traveling abroad or outside their otherwise common or familiar neighborhoods often will not know the zip code in which they are currently located, and accordingly they cannot readily supply it to a traditional Internet shopping engine, even if they had access thereto. While it may be argued that impromptu shopping is a frivolous or unimportant diversion when a person is outside his or her familiar neighborhoods, this argument fails to appreciate that the comparison shopping may be for products such as gasoline or food. For such occasions, impromptu comparison shopping has the potential to save the consumer money on products that will otherwise be used or needed before the consumer has an opportunity to return to more familiar surroundings.

Accordingly, a new and improved method and/or system for comparison shopping via a wireless telecommunications network is disclosed that overcomes the above-referenced problems and others.

### SUMMARY

In accordance with one embodiment, a method of providing a location-based comparative shopping service to a subscriber includes: receiving a request to conduct a search for a product from the subscriber via a mobile station being served by a wireless telecommunications network; determining a location of the mobile station; generating a query from at least one of the received request and the determined location; submitting the query to a shopping engine, the shopping engine generating results in response thereto, the results including a number of entries satisfying the query; receiving the result entries generated by the shopping engine; and, forwarding selected result entries to the mobile station via the wireless telecommunications network and/or its associated packet data network.

In accordance with another embodiment, a system for providing a location-based comparative shopping service includes: request receiving means for receiving a request to conduct a search for a product from the subscriber via a mobile station being served by a wireless telecommunications network; location determining means for determining a location of the mobile station; query generating means for generating a query from at least one of the received request and the determined location; query submitting means for submitting the query to a shopping engine, the shopping engine generating results in response thereto, the results including a number of entries satisfying the query; result receiving means for receiving the result entries generated by the shopping engine; and, forwarding means for forwarding selected result entries to the mobile station via the wireless telecommunications network and/or its associated packet data network.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary telecommunications network including a location-based comparison shopping service suitable for practicing aspects of the present inventive subject matter.

FIG. 2 is a flow chart showing an exemplary operation of a location-based comparison shopping service embodying aspects of the present inventive subject matter.

### DETAILED DESCRIPTION

For clarity and simplicity, the present specification shall refer to structural and/or functional elements, entities and/or facilities, relevant communication standards, protocols and/or services, and other components and features that are commonly known in the art without further detailed explanation as to their configuration or operation except to the extent they have been modified or altered in accordance with and/or to accommodate the embodiment(s) presented herein.

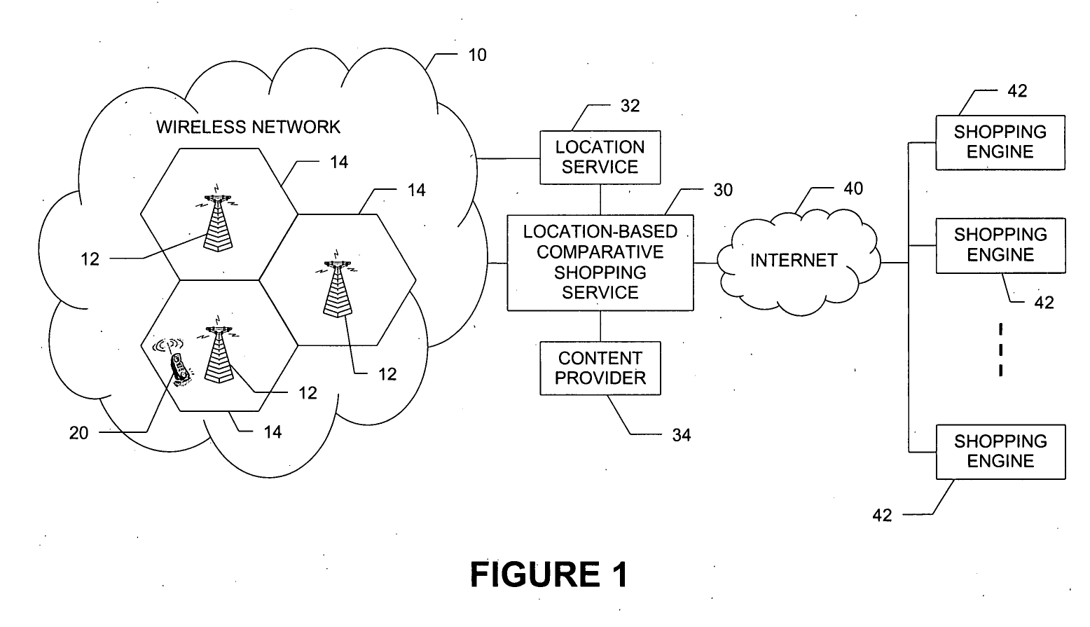

With reference to FIG. 1, a wireless telecommunications network 10 includes, in the usual manner, a plurality of base stations (BS) 12. As is understood in the art, each BS 12 provides an over-the-air radio frequency interface for a respective geographic area or cell 14. Selectively, a mobile station (MS) 20 (e.g., in the form of a mobile telephone or any other suitable wireless end user terminal) is provided telecommunication services and/or otherwise accesses the network 10 via the interface and/or BS 12 serving the cell 14 in which the MS 20 is located. While only three BS 12 and three corresponding cells 14 are illustrated in FIG. 1 for purposes of simplification and clarity, it is to be appreciated that the network 10 in practice includes any number of one or more BS and/or cells that are similarly situated and/or arranged. Additionally, while only one exemplary MS is illustrated in FIG. 1, the network 10 optionally serves any number of one or more mobile stations similarly situated and/or arranged in any of the one or more cells 14.

As illustrated, a location-based comparative shopping (LBCS) service 30 is provided to and/or accessible by the MS 20 via the wireless network 10. Suitably, access to LBCS service 30 by the MS 20 is via the usual packet session establishment procedures. For instance, in a CDMA (Code Division Multiple Access) network, the MS 20 establishes a PPP (Peer-to-Peer Protocol) session with the help of a PDSN (Packet Data Service Node). Similarly, in a GPRS/UMTS (General Packet Radio Service/Universal Mobile Telecommunications System) network, the MS 20 establishes a PDP (Packet Data Protocol) session with the help of SGSN (Serving GPRS Support Node) and GGSN (Gateway GPRS Support Node). These additional network elements are not shown separately in the figure for the sake of clarity and/or brevity; nevertheless, the illustrated wireless network 10 subsumes the related functionality. Suitably, the packet data session itself is established prior to the MS 20 connecting to the LBCS service 30. The LBCS service 30 is suitably implemented as a web service accessible from the MS 20. Alternately, the LBCS service 30 resides at any other convenient network facility and/or node. Suitably, the LBCS service 30 is implemented via a program and/or other appropriate software running on an application server, however, it may alternately be implemented in any suitable fashion and/or on another suitable platform or equipment. Optionally, the service 30 is only made available to a user of the MS 20 if they have a proper subscription thereto. Accordingly, subscription information is maintained in a subscriber database (DB) or register which is queried to determine the subscription status prior to actual implementation of the service 30. For example, the subscriber DB optionally has a list stored therein, and/or otherwise maintains data or information that indicates, which MS and/or users accessing the wireless network 10 (e.g., identified by their telephone numbers or other like identifiers) do and/or do not subscribe to the service 30.

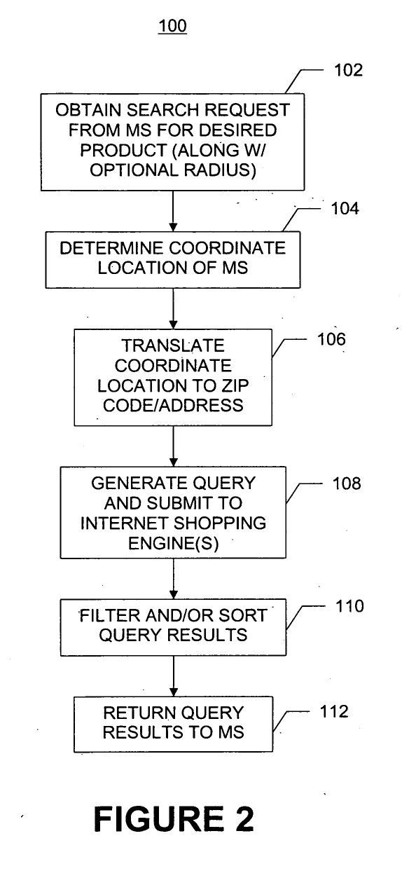

In general terms, the LBCS service 30 provides a subscriber the ability to use their MS 20 to comparison shop on an impromptu and/or essentially real-time basis for desired goods and/or services within a selected geographic vicinity or proximity of their current location. More specifically, with reference to FIG. 2, an exemplary process 100 illustrates the operation of the LBCS service 30. For example, at step 102 of process 100, the LBCS service 30 obtains a search request for a desired item or product. That is to say, a subscriber uses their MS 20 to submit a search request for a desired item or product, and the request is sent via the wireless network 10 to the LBCS service 30.

Suitably, the MS 20 includes and/or provides a user-interface for the user to specify the item or product of interest. Optionally, in the simplest form, the user employs a keypad of the MS 20 to enter the item or product. Suitably, the item or product is specified by any one or more of the following: its name, key word or other descriptions, part number, brand, model number, SKU number, etc. To permit an alternate form of user input, the LBCS service 30 is optionally equipped or provisioned with or has access to voice and/or speech recognition capabilities, e.g., so that the user input maybe simply spoken into a microphone or the like equipped on the MS 20. In yet another alternative, the MS 20 is equipped and/or provisioned with a bar code reader. Accordingly, when the user is already at a particular merchant's location, the user may simply scan the bar code of an item or product for which they wish to comparison shop. Suitably, upon receiving the bar code from the MS 20, the LBCS service 30 accesses a database or the like to identify the item corresponding to the bar code. In yet another embodiment, the MS 20 is optionally equipped and/or provisioned with a digital camera or video capture equipment, e.g., as in the case of a mobile camera phone or video phone. Accordingly, the user merely takes a picture or video of the item or its bar code or its SKU number and transmits the same to the LBCS service 30 over the packet data network associated with the wireless network 10. The LBCS service 30 then employs a suitable picture recognition program, bar code reader, optical character recognition program or other suitable device or technique to identify the object.

Optionally, along with the search request or in another message similarly submitted and/or sent to the LBCS service 30 from the MS 20 over the wireless network 10, a selected radius is also specified or designated by the subscriber. In response to receiving the request and/or radius, at step 104, the LBCS service 30 obtains and/or identifies the current location of the MS 20. For example, the location of the MS 20 is obtained by the LBCS service 30 from a location service 32 that operates in the usual manner to monitor and/or find the location of the MS 20 within the wireless network 10. Suitably, the location of the MS 20 is established in accordance with and/or by any one or more known methods and/or approaches. That is to say, in practice, the location service 32 uses any one or more of various known techniques to measure or detect the current location of the MS 20. For example, the MS 20 is optionally equipped with a global positioning system (GPS) receiver or other like device from which the location of the MS 20 is obtained by the location service 32. Alternately, a network or MS-based technique is employed by the location service 32 to determine or measure the location of the MS 20, e.g., using the over-the-air interfaces and/or signals exchanged between the MS 20 and one or more of the BS 30. For example, suitable known network and/or MS-based solutions for determining the location of the MS 20 include, without limitation: observed time difference (OTD); time of arrival (TOA); time difference of arrival (TDOA); angle of arrival (AOA); multipath fingerprinting; timing advance (TA); enhanced forward link triangulation (E-FLT); received signal strength (RSS); etc. Optionally, a hybrid location determination solution combining one or more of the aforementioned techniques is employed or so-called assisted-GPS may also be employed.

In a suitable embodiment, the location information communicated by the location service 32 to the LBCS service 30 is optionally in the form of latitude and longitude coordinates corresponding to the current location of the MS 20. Accordingly, at step 106, the LBCS service 30 identifies, determines or otherwise obtains the corresponding geographic designation or position (e.g., zip code and/or street address) for the received latitude and longitude coordinates. For example, the LBCS service 30 optionally submits the latitude and longitude coordinates for the MS 20 (i.e., the coordinates received from the location service 32) to a content provider 34 or other like entity or service for translation and/or reverse geo-coding. In response, the content provider 34 returns to the LBCS service 30 the corresponding geographic designation or position, e.g., in the form of a zip code and/or street address.

At step 108, the LBCS service 30 generates an appropriate query from the obtained request (i.e., the specified item or product indicated in the request received from the subscriber in step 102) and the determined geographic location of the MS 20 (i.e., the zip code and/or address obtained in step 106). The formulated query is in turn submitted and/or sent over the Internet 40 or another similar and/or suitable network to one or more traditional shopping engines and/or websites 42, e.g., such as Froogle, Yahoo!® Shopping, PriceGrabber.com, BizRate, GasBuddy.com, GasPriceWatch.com, or other like shopping engines and/or websites as are commonly known in the art. Suitably, the LBCS service 30 forms and/or formats each query for the particular shopping engine 42 to which it is being submitted, i.e., in the form and/or format expected and/or designated by the respective shopping engines 42. The query, for example, identifies and/or describes the item or product for which the subscriber is searching and optionally includes the geographic designation (i.e., zip code or the like) in which the search is to be performed.

The shopping engines 42, having received the query from the LBCS service 30, perform the designated searches in their usual fashion and return the results to the LBCS service 30. For example, the results from each shopping engine 42 include a list of items or products matching or satisfying the search criteria, along with the identity of the merchants that are offering them for sale. Each entry in the results also optionally includes the price at which the item or product is being offered for sale and/or the location of the merchant offering the item or product for sale. Optionally, where the query includes a specific geographic designation (e.g., a specific zip code) and the particular shopping engine 42 is so enabled, the returned results include only those entries wherein the item or product is available for purchase within that geographic designation.

At step 110, the results returned from the shopping engines 42 (e.g., via the Internet 40) are optionally filtered and/or sorted by the LBCS service 30, before being forwarded via the wireless network 10 back to the MS 20, as shown at step 112. For example, suitably, the results or entries corresponding to items or products for sale by merchants outside the radius specified by the subscriber are filtered out. That is to say, for example, the LBCS service 30 compares the location of a merchant identified in a given result entry returned from one of the shopping engines 42 to the current location of the MS 20 (i.e., the location obtained by the LBCS service 30 from the location service 32 and/or the content provider 34), and if the distance between the two locations is greater than the radius specified by the user (i.e., the radius obtained by the LBCS 30 in step 102), then that result entry is filtered out and/or omitted from those result entries that are ultimately forwarded or otherwise sent back to the MS 20 in step 112. Suitably, the results are also sort by the LBCS service 30 according to their corresponding price, or alternately according to distance, e.g., as measure or calculated from the current location of the MS 20. In step 112, the results are then provided to the subscriber in accordance with the sorted order, e.g., with the closest and/or lowest priced entries or results being provided before the farther and/or higher price entries or results. At this stage, the user or subscriber has sufficient information to make a knowledgeable and/or informed decision about their contemplated purchase. In addition, the LBCS service 30 also optionally provides other auxiliary and/or complementary information to the MS 20, e.g., such as telephone numbers and/or links to driving directions from the current location of the MS 20 to each of the entries in the returned results. In this manner, the subscriber can use the telephone number to call the merchant to make relevant inquiries (e.g., to determine if the item or product of interest is currently in stock), and/or use the supplied link to obtain driving directions to assist their travel to the merchant's location.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of providing a location-based comparative shopping service to a subscriber, said method comprising:
(a) receiving a request to conduct a search for a product from the subscriber via a mobile station being served by a wireless telecommunications network;
(b) determining a location of the mobile station;
(c) generating a query from at least one of the received request and the determined location;
(d) submitting the query to a shopping engine, said shopping engine generating results in response thereto, said results including a number of entries satisfying the query;
(e) receiving the result entries generated by the shopping engine; and,
(f) forwarding selected result entries to the mobile station via a packet data network associated with the wireless telecommunications network.

2. The method of claim 1, wherein the query is submitted to the shopping engine over the Internet.

3. The method of claim 1, wherein step (b) comprises:
obtaining latitude and longitude coordinates for the mobile station; and,
translating the coordinates into at least one of a zip code and a street address corresponding to the coordinates.

4. The method of claim 1, wherein said result entries received in step (e) also identify where respective products listed in the entries are available for purchase.

5. The method of claim 4, further comprising:
sorting the result entries according to distance from the current location of the mobile station before forwarding them to the mobile station.

6. The method of claim 4, further comprising:
receiving a specified radius in connection with the received request; and,
filtering out those entries having a distance from the current location of the mobile station which is greater than the radius, such that the filtered out entries are omitted from those forwarded to the mobile station in step (f).

7. The method of claim 1, wherein the product is specified in the request using at least one of the following: a name, a description, a model number, a brand, a bar code, a SKU number, or an image.

8. The method of claim 1, wherein the mobile station includes at least one of a keypad, a camera, a bar code reader, a microphone or a video recorder that the subscriber uses to input a specification for the product sought in the request.

9. A system for providing a location-based comparative shopping service to a subscriber, said system comprising:
request receiving means for receiving a request to conduct a search for a product from the subscriber via a mobile station being served by a wireless telecommunications network and its associated packet data network;
location determining means for determining a location of the mobile station;
query generating means for generating a query from at least one of the received request and the determined location;
query submitting means for submitting the query to a shopping engine, said shopping engine generating results in response thereto, said results including a number of entries satisfying the query;
result receiving means for receiving the result entries generated by the shopping engine; and,
forwarding means for forwarding selected result entries to the mobile station via the wireless telecommunications network and its associated packet data network.

10. The system of claim 9, wherein the query is submitted to the shopping engine over the Internet.

11. The system of claim 9, wherein the location determining means comprises:
coordinate obtaining means for obtaining latitude and longitude coordinates for the mobile station; and,
translating means for translating the coordinates into at least one of a zip code and a street address corresponding to the coordinates.

12. The system of claim 9, wherein said result entries received by the result receiving means also identify where respective products listed in the entries are available for purchase.

13. The system of claim 12, further comprising:
sorting means for sorting the result entries according to distance from the current location of the mobile station before they are forwarded by the forwarding means.

14. The system of claim 12, further comprising:
radius receiving means for receiving a specified radius in connection with the request received by the request receiving means; and,
filtering means for filtering out those entries having a distance from the current location of the mobile station which is greater than the radius, such that the filtered out entries are omitted from those forwarded by the forwarding means.

15. The system of claim 9, wherein the product is specified in the request using at least one of the following: a name, a description, a model number, a brand, a bar code, a SKU number, or an image.

16. The system of claim 9, wherein the mobile station includes at least one of a keypad, a camera, a bar code reader, a microphone or a video recorder that the subscriber uses to input an identification of the product sought in the request.
